(19) United States
(12) Patent Application Publication
(10) Pub. No.: US 2014/0300078 A1
(43) Pub. Date: Oct. 9, 2014

(54) DEVICE FOR THE PROPULSION AND ECCENTRIC BRAKING OF A VEHICLE

(71) Applicants: Kurt Ruffieux, Thalwil (CH); Stefan Stahl, Berikon (CH); Andreas Kaiser, Zurich (CH)

(72) Inventors: Kurt Ruffieux, Thalwil (CH); Stefan Stahl, Berikon (CH); Andreas Kaiser, Zurich (CH)

(73) Assignee: SYNERGY BIOSURGICAL AG, Zug (CH)

(21) Appl. No.: 14/239,457

(22) PCT Filed: Aug. 17, 2011
(86) PCT No.: PCT/CH2011/000184

§ 371 Date: May 17, 2014

(51) Int. Cl. B62M 9/06; B62L 5/00

(52) U.S. Cl. CPC B62M 9/06; B62L 5/00; B62L 5/006
USPC 280/261; 474/1

(57) ABSTRACT

A device for the propulsion and eccentric braking of a vehicle having a pedal drive, which includes a first shaft, a drive mechanism including one or a plurality of chain wheels, belt pulleys or elements of a Cardan drive, a second hollow shaft arranged concentrically about the first shaft mounted into a rear wheel, a freewheel clutch mounted between the first shaft and the drive mechanism, and an optionally engageable reverse gear mechanism mounted between the first and the second shaft. The first and the second shafts are connected to each other in a torsionally rigid manner when the reverse gear mechanism is in the engaged and disengaged state. The freewheel clutch prevents a rotation of the drive mechanism relative to the first shaft in a clockwise direction and is in a freewheeling state when the drive mechanism rotates in a counter-clockwise direction relative to the first shaft.

The invention relates to a device for the propulsion and eccentric braking of a vehicle having a pedal drive according to the preamble of Claim 1, to a vehicle having a pedal drive and a device according to the invention according to the preamble of Claim 12, and to a method for eccentric muscle training using a vehicle according to the invention according to the preamble of Claim 24.

Bicycles are usually propelled using pedals that are pedaled by the feet. For a forward movement, the pedals for this purpose are usually pedaled in the forward direction, which results in an optical loading of the joints and of the muscles. When riding downhill, the pedals can be immobile, and a freewheel mechanism allows the wheel to roll freely without the pedal rotating along with it. Brake shoes, drum brakes, disc brakes or other energy-converting mechanisms operated by a hand lever or a back pedaling mechanism, are used as brakes.

From U.S. Pat. No. 7,445,223 HONG, a bicycle drive system having a reverse gear mechanism is known, wherein, by engaging or disengaging the reverse gear mechanism, it is possible to achieve that the bicycle moves forward, when the pedals are pedaled in a forward or backward rotation direction. The reverse gear mechanism is mounted on the pedal axle bearing. During the forward rotation of the pedal axle, the torque exerted via the pedals is transmitted by a one-way clutch to the chain wheel, so that the rear wheel rotates in the forward direction, while, when the reverse gear mechanism is engaged, during the backward rotation of the pedal axle, the torque exerted via the pedals is transmitted by an additional one-way clutch via a planetary gear train to the chain wheel, so that the rear wheel also rotates in the forward direction. Since the two one-way clutches transmit a torque only from the pedal axle to the chain wheel, and in both cases no torque is transmitted from the rear wheel to the pedal axle by the two one-way clutches, no braking effect can be applied onto the rear wheel by a backward rotation of the pedal axle. The gear mechanism mounted in the bottom bracket makes it possible to change the pedaling direction by switching over. Here, the rotation direction of the chain wheels remains the same.

However, there are biomechanical aspects pertaining to sports physiology that make an active braking of the speed by the muscles (so-called “eccentric training”) appear attractive. However, this is not possible in a reasonable way with bicycles of the current prior art.

This situation is to be remedied by the invention. The invention is based on the problem of providing a device for eccentric training that can be built into a vehicle having a pedal drive, in particular into a bicycle.

Eccentric muscle work is of great importance in numerous daily activities and in sports, such as in braking movements when landing, in skiing and or in walking downhill. In jogging as well, the proportion of eccentric muscle work is high. Each time a foot is set down, the muscle-tendon system is expanded resiliently like a spring. During the immediately following push off by the leg, this resilient spring energy contributes up to 50 percent to the forward movement power. This property of the muscles is also put to use in running and jumping animals. Extensive or unusual eccentric muscle work leads to mechanical damage to the muscle cells. We then experience this for one to two days after the strain in the form of an intense muscle ache.

The invention solves the posed problem with a device for the propulsion and braking of a vehicle having a pedal drive, which has the features of Claim 1, as well as with a vehicle having a pedal drive, which comprises the device according to the invention, and which has the features of Claim 12, and with a method for eccentric muscle training using a vehicle according to the invention, which has the features of Claim 24.

The advantages achieved by the invention are essentially that, by means of the device according to the invention:
the muscles are stretched against their resistance and thus loaded and trained in another manner than in concentric training. The advantages of this reversal of movement are, on the one hand, a reduction in oxygen consumption by a factor of up to 5, with the same amount of work and the same, or even increased, muscle buildup. The muscles and joints are loaded in the braking movement with the same force vectors as during the active forward movement of the bicycle, but now in the opposite direction of movement of the muscles (i.e., for example, the pedals and the feet rotate in the backward direction with braking action, while the bicycle rolls downhill, for example). This has also been found to be advantageous for joint loading, because in this manner the optimal loading conditions for muscles and joints are achieved;
the locomotion apparatus (muscles, tendons, ligaments, bones and joints) is loaded over-proportionally in comparison to the circulation. The energy consumption and thus the vascular stress are clearly lower in the case of eccentric muscle work compared to similar concentric loading; and
a compact design of the propulsion device can be achieved, so that only a few changes need to be made to an existing bicycle. It is also possible to carry out only a retrofitting of existing bicycles. A conventional derailleur cassette with a freewheel clutch can be used, so that all the components from the crank to the derailleur cassette of a conventional sprocket shifter can be used in accordance with the standard of existing bicycles. Thus, it remains open whether the product is sold in the form of a complete special bicycle or home trainer or also as a retrofitting kit.

Advantageous embodiments of the invention can be commented on as follows:

In a special design of the device, the freewheel clutch, viewed from the drive means, prevents a clockwise rotation of the drive means relative to the first shaft, while the freewheel clutch is in the freewheel state when the drive means rotate counterclockwise relative to the first shaft. Commercial devices can be used as freewheel clutch and drive means. In the drive mode of the device, i.e., when the reverse gear mechanism is disengaged, the bicycle can be propelled in the conventional manner, whereas, when the reverse gear mechanism is engaged, i.e., in the braking mode when riding downhill or in the case of a forward movement of the bicycle caused by an electric drive, a force transmission from the forward rotating rear wheel to the pedal axle which rotates in the opposite direction, i.e., backward, occurs, so that the bicycle can be braked eccentrically by muscle force. In order for the force transmission from the wheel to the crank to take place, the reverse gear mechanism has to be arranged, starting from the wheel side, in front of the freewheel.

In an additional embodiment of the device, the first shaft is designed as a hollow shaft. In this manner it is possible to achieve the advantage that the first shaft can be mounted on the axle of a bicycle rear wheel. By means of such a commercial axle, for example, with quick releases, the entire reverse gear mechanism can be secured to the rear wheel fork of a bicycle frame.

In another embodiment, the device comprises an automatic overload protection, by means of which the reverse gear mechanism can be disengaged, so that the device can be switched over from the braking mode to the drive mode. This embodiment allows the advantage that, when the overload protection, for example, of a centrifugal force control, is activated, the reverse gear mechanism is switched over to the drive mode, and the drive force is no longer transmitted from the rear wheel to the pedals, and the bicycle can roll downhill, without accompanying rotation of the pedals.

In an additional embodiment, the device comprises a clutch. As a result, when rolling downhill, the brake mode can be switched on without impact forces. The clutch can be designed as a clutch that can be engaged or disengaged or as a resilient clutch that is not switchable, and it can be mounted, for example, in the reverse gear mechanism.

In an additional embodiment of the device, the reverse gear mechanism comprises a planetary gear train.

In yet another embodiment, the device comprises a braking/freewheel system, which can be activated when the reverse gear mechanism is engaged, and which, in the braking mode, causes alternating braking and freewheel modes of the drive means. The braking/freewheel system can perform in rapid succession alternating locking and freewheel modes, for example, clamping and release movements, which leads to rocking of the pedal during brake loading (rocking mechanism).

In an additional embodiment, the device, preferably the reverse gear mechanism, comprises a transmission. In this manner, it is possible to achieve the advantage that, before downhill riding and eccentric training, the rider can engage a certain gear and thus adapt himself/herself to the downhill grade in question. In order to be able to generate approximately the same torque in the case of a different grade of the roadway, changing transmission ratios are needed in the case of the force transmission from the crank to the rear axle. This also applies to the transmission of the braking force in the reverse direction.

In an additional embodiment of the device, the freewheel clutch can be locked, for example, when the reverse gear mechanism is engaged. By pushing the pedals backward, the bicycle can thus be propelled in forward direction. When bicycling, it is also pleasant to occasionally backpedal actively concentrically, for example, to continue moving over slight ascending slopes.

In an additional embodiment, the device comprises a measuring device for measuring the braking power in the braking mode and/or the driving power in the drive mode as well as preferably a microcomputer. The measuring device can be incorporated in the rear wheel hub of the bicycle. By means of a computer which is also incorporated, and as a result of a simultaneously performed pulse measurement, the vehicle can also be used therapeutically or for competitive sports.

In an additional embodiment, the device comprises an activation device for engaging and disengaging the reverse gear mechanism.

In a special embodiment of the vehicle, the reverse gear mechanism can be integrated in the at least one rear wheel.

In an additional embodiment of the vehicle, the brake device comprises a brake lever, so that, when the brake lever is activated, the reverse gear mechanism can be disengaged. In this manner it is possible to achieve the advantage that, if the driving force transmitted from the rear wheel to the pedals becomes excessively high in the braking mode during downhill riding, the freewheel clutch can be switched over to the drive mode by activating the brake lever, so that the freewheel clutch is in the freewheel state while the rear wheel rotates in the forward direction. As a result of this safety mechanism, the bicycle is switched over to an operation like that of a commercial bicycle if the braking force is excessively high.

In another embodiment, the vehicle comprises a measuring device for measuring the braking power in the braking mode and/or the driving power in the drive mode as well as preferably a microcomputer. Usually, in the case of a bottom bracket, a torque sensor is incorporated on the front chain wheel or the front chain wheels, and the power is calculated via the pedaling frequency which is also detected. Alternatively, the measuring device can be incorporated in the rear wheel hub of the vehicle. By means of a computer, which is also incorporated, and a simultaneously performed pulse measurement, the vehicle can also be used therapeutically or for competitive sports.

In an additional embodiment, the vehicle comprises an activation device, preferably a switch lever, by means of which the switching device can be activated.

In an additional embodiment, the vehicle comprises an electric drive, by means of which the vehicle can be propelled in the forward direction.

In an additional embodiment of the vehicle, the electric drive comprises a programmable microcomputer by means of which the driving force and/or the rotational speed of the electric drive can be set. In this manner, it is possible to achieve the advantages that, for example, the load pattern can be programmed for training purposes, for a diagnosis or for a treatment. Furthermore, it is made possible that, the more a training individual brakes in the braking mode, i.e., trains eccentrically, the more rapidly the bicycle is driven by the electric drive, which makes it possible to achieve a motivating effect.

In an additional embodiment, the vehicle comprises a force sensor by means of which the driving force of the electric drive can be adjusted. In this manner, given a certain selected rotational speed, the driving power can be adapted to the needs of the user.

In yet another embodiment of the vehicle, the electric motor can also be operated as a generator.

In an additional embodiment of the vehicle, an additional motor/generator group is arranged on at least one rear wheel. As a result, it is possible to achieve the advantage that there are two mechanically separated functional groups. The first is connected to the bottom bracket and thus in direct mechanical contact with the rider. The motor in the bottom bracket can here also be operated as a generator. In addition, a motor/generator group sits in the rear wheel hub. The connection between the two functional groups is an electric storage/accumulator. During braking, the motor (in the bottom bracket) propels the bicycle and draws energy from the accumulator. In the drive mode, the motor acts as a generator, and it supplies the accumulator. The behavior of the functional group on the rear wheel is exactly the same. Due to the mechanical disengagement of the two functional groups, the system is highly variable.

The vehicle according to the invention is preferably used for eccentric muscle training.

Additional preferred uses of the vehicle according to the invention are its use in diagnostic and/or therapeutic procedures, particularly in the rehabilitation training of heart patients. The advantage of these uses of the vehicle according to the invention is that the energy consumption and thus the vascular stress during eccentric muscle work are considerably lower than during comparable concentric loading. The locomotion apparatus (muscles, vision, ligaments, bones and joints) are loaded over-proportionally in comparison to the circulation. This property can be exploited, for example, in the rehabilitation training of heart patients.

In a special embodiment of the method, the propulsion of the vehicle in the forward direction occurs while rolling downhill.

In an additional embodiment of the method, the propulsion of the vehicle in the forward direction can occur alone or in addition by means of an electric motor.

The invention and variants of the invention are explained in even more detail below in reference to the partially diagrammatic representations of several embodiment examples.

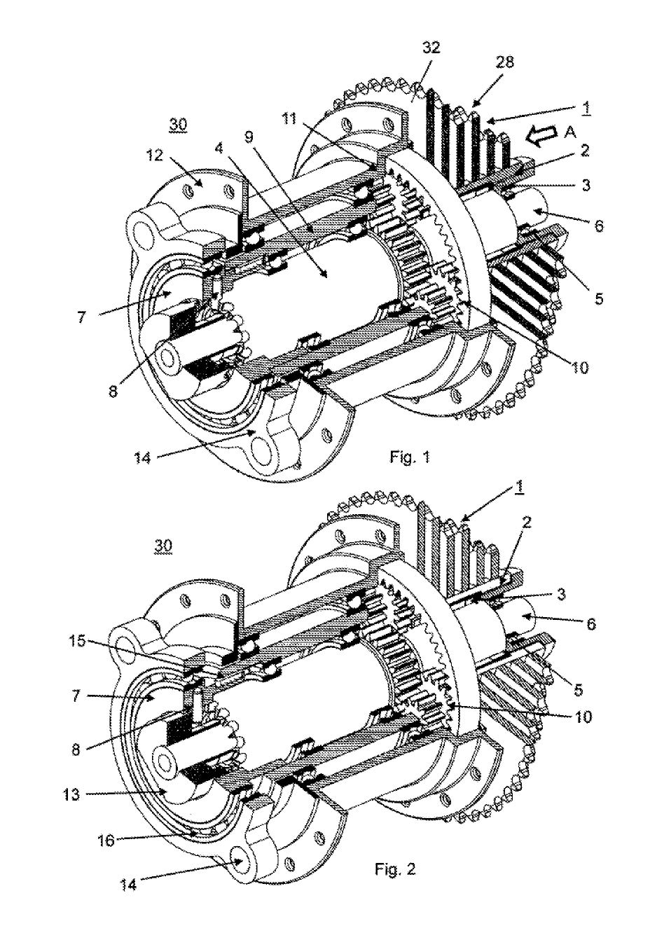

FIG. 1 shows a perspective, partially cutaway, view of an embodiment of the device according to the invention in the drive mode;

FIG. 2 shows a perspective, partially cutaway, view of the embodiment of the device according to the invention represented in FIG. 1 in the braking mode;

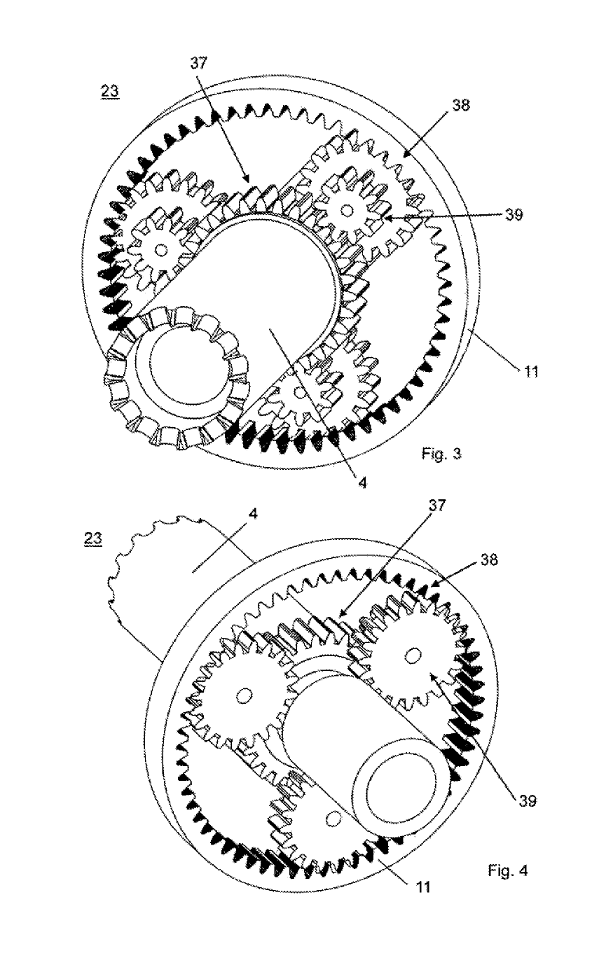

FIG. 3 shows a perspective, partially cutaway, view of the planetary gear train of the embodiment of the device according to the invention represented in FIG. 1 from the side of the switching device;

FIG. 4 shows a perspective, partially cutaway, view of the planetary gear train of the embodiment of the device according to the invention represented in FIG. 1 from the side of the driving means;

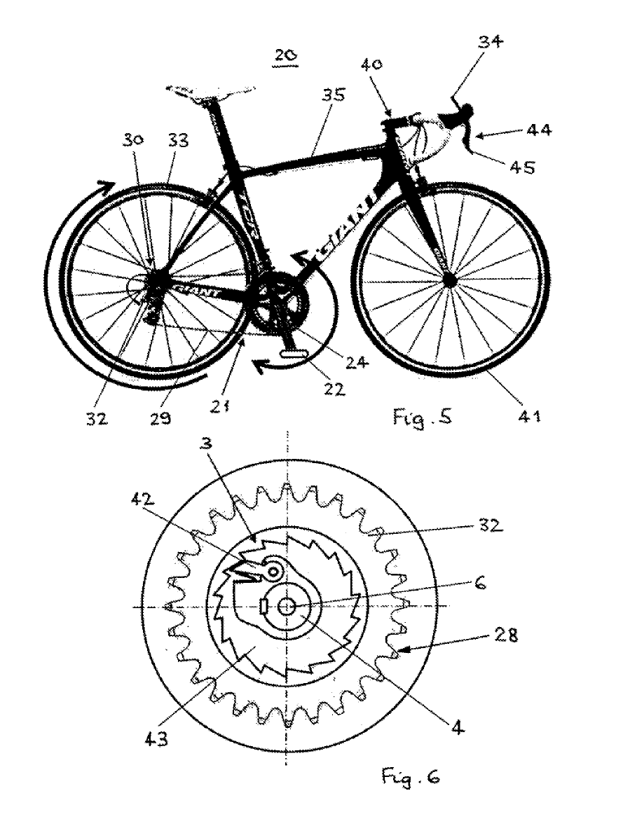

FIG. 5 shows a view of an embodiment of the vehicle according to the invention; and

FIG. 6 shows a section through the freewheel clutch of an embodiment of the device according to the invention.

The embodiment of the device 30 according to the invention represented in FIGS. 1 to 4 is designed as a special functional hub for a rear wheel 33 of a vehicle, in particular of a bicycle 20 (FIG. 5). The retrofitting of a bicycle 20 (FIG. 5) accordingly requires only a special, novel rear wheel 33 in addition to a gear mechanism attachment to the wheel suspension (lug on the frame) and a switch lever 34 in the area accessible to the grip of the rider, preferably on the vehicle frame 35 close to the steering bearing or on the steering device 40.

All the components from the crank to the derailleur cassette 1 of a conventional sprocket shifter can be used in accordance with the standard of existing bicycles. The interface between the device 30 and the conventional system is the derailleur cassette 1, or the groove seat 2 of the derailleur cassette 1 on the first shaft 4 designed as a hub.

Directly beneath the groove seat 2, the freewheel clutch 3 (FIG. 6) is located, which—viewed in the direction of the arrow A in FIG. 1—during a rotation of the groove seat 2, which is connected in a torsionally rigid manner to the rear chain wheels 32, in a first direction (clockwise), grips the inner shaft 4 and as it were moves it along. In the opposite direction (counterclockwise), no coupling between the inner shaft 4 and the groove seat 2 occurs.

The inner shaft 4 is mounted by means of the two main bearings 5 on the axle 6 of the rear wheel 33. By means of a commercial quick-release axle with quick releases (not shown), the entire device 30 is secured in the rear wheel fork of a vehicle frame 35.

By means of a switching device 14, a switch is made between the drive mode with the reverse gear mechanism 23 in the disengaged state and the braking mode with the reverse gear system 23 in the engaged state. This occurs by shifting the switching sleeve 7 into its right or left position.

### Drive Mode (FIG. 1):

The switching sleeve 7 of the switching device 14 is located in the position on the right and it forms with its radially arranged pins 8 a rigid connection between the inner shaft 4 and the center hollow shaft 9. The entire planetary gear train 10 is locked by means of the torsionally rigid connection of the inner shaft 4 to the center hollow shaft 9. As a result, the second shaft 11 designed as an outer hollow shaft also moves with the sockets for the spokes 12 of the rear wheel 33, in uniform motion with the first shaft 4 and the center hollow shaft 9.

Due to the locking of the reverse gear mechanism 23, the device 30 behaves like a conventional rear wheel hub which rotates about the main bearing 5 on the axle 6 of the rear wheel 33. In the drive mode, the device 30 will therefore also no longer have inner friction, like a conventional wheel hub, i.e., it has the same efficiency of energy transmission.

### Braking Mode (FIG. 2):

The switching device sleeve 7 is located in the position on the left. The pins 8 engage in the holding portion 13 which is attached on the axle 6, which in turn is secured in a torsionally rigid manner on the vehicle frame 35. Thus, the center hollow shaft 9 is connected rigidly to the vehicle frame 35 and it can no longer rotate. Since the first shaft 4 and the second shaft 11 are now mounted freely rotatably, they will rotate in the opposite direction forced by the planetary gear train 10.

During forward rolling, for example, during downhill rolling, the rear wheel 33 and thus the second shaft 11 with the spoke sockets 12 rotate clockwise. The planetary gear train 10 performs the reversal of the direction of rotation, so that the inner first shaft 4 now rotates counterclockwise. The freewheel clutch 3 again locks in this direction of rotation the relative movement of the first inner shaft 4 with respect to the groove seat 2 and the rear chain wheels 32 of the derailleur cassette 1. Thus, a force transmission from the rear wheel 33 to the rear chain wheels 32 of the derailleur cassette 1 occurs via the chain of the chain drive 29 to the crank 24. The rotation directions of the rear wheel 33 and of the crank 24 are opposite in the braking mode (FIG. 5).

The reversal of the rotation direction via the reversal gear mechanism is associated with friction. During the force transmission, more loss of efficiency must be expected therefore than in the case of a simple chain drive (efficiency between 85% and 95%).

The planetary gear (FIGS. 3 and 4) consists of a first gear wheel 37 on the inner first shaft 4, of a second gear wheel 38 with inner toothing on the outer second shaft 11, and of several smaller gear wheel pairs 39 with axial seat on the center hollow shaft 9.

Alternatively, it would also be possible to replace the gear wheel pairs 39 in each case with a single gear wheel which is in direct engagement with the first gear wheel 37 and the second gear wheel 38. However, this would mean that in the braking mode a gear reduction of the circumferential speeds from the rear wheel 33 to the chain wheels 32 of the drive device 21 occurs. However, it is advantageous that when braking from high speeds the crank 24 moves only slowly backward (low pedaling frequency), so that the rider must/can generate large braking torques. For this reason, a transmission is incorporated with the gear wheel pairs 39.

The switching device 14 ensures that the switching sleeve 7 can be shifted relative to the first and the second shaft 4; 11 and the center hollow shaft 9. The switching sleeve 7 is connected in a torsionally rigid manner by keys 15 to the center hollow shaft 9 and it connects the center hollow shaft 9 via the pins 8 either to the inner first shaft 4 in the drive mode or to the vehicle frame 35 in the braking mode.

The shifting of the switching sleeve 7 can be carried out, for example, by two hydraulic cylinders (not shown) attached on the vehicle frame 35. Said hydraulic cylinders, because they are rigidly connected to the vehicle frame 35 or to the holding part 13, are connected via an additional roller bearing 16 to the switching sleeve 7.

The embodiment of the vehicle according to the invention having a pedal drive, which is represented in FIG. 5, is designed as a bicycle 20 and it comprises substantially a vehicle frame 35 having a steering device 40, a rear wheel 33, a front wheel 41, a braking device 44, a drive device 21 and a device 30 according to FIGS. 1 to 4.

The drive device 21 comprises a crank 24 which can be propelled by a pedal 22 and a chain drive 29 arranged between the crank 24 and the rear wheel 23. Alternatively, a belt drive or a cardan drive can be arranged between the crank 24 and the rear wheel 23.

The freewheel clutch 3 is designed, for example, as a ratchet and pawl mechanism and it comprises a first pawl 42 which, in the drive mode when the chain wheel 32 rotates in the forward direction (clockwise), is in engagement with the ratchet wheel 43, so that a force transmission occurs in the forward direction of movement from the chain wheel 32 to the first shaft 4 mounted rotatably on the axle 6 of the rear wheel 23 (FIG. 6). Alternatively, instead of the ratchet and pawl mechanism, any commercial freewheel clutch 3 can be incorporated in the device 30.

The braking device 44 comprises a brake lever 45, which is connected to the rear wheel brake and which, in the drive mode, operates only the rear wheel brake, and, in the braking mode, when the brake lever 45 is actuated, the reverse gear mechanism 23 is switched over from the braking mode, i.e., from the switched on state, into the drive mode.

Although there are various embodiments of the device according to the invention as described above, it should be understood that the various features can be used either individually or also in any desired combination. The invention is therefore not simply limited to the above-mentioned, particularly preferred embodiments.

1. A device for the propulsion and eccentric braking of a vehicle having a pedal drive, comprising:
a first shaft having a longitudinal axis and drive means comprising one or more chain wheels, belt pulleys or elements of a cardan drive;
a second shaft in the form of a hollow shaft arranged concentrically about the first shaft and which is mountable into a rear wheel of the vehicle;
freewheel clutch which is mounted between the first shaft and the drive means;
an optionally engageable and disengageable reverse gear mechanism which is mounted between the first and the second shaft, wherein an opposite rotation direction is generated between the first and the second shaft when the reverse gear mechanism is in the engaged state, and a rotation in the same direction is generated between the first and the second shaft when the reverse gear mechanism is in the disengaged state; and
a switching device for engaging and disengaging the reverse gear mechanism;
wherein the first shaft and the second shaft are connected to each other in a torsionally rigid manner in both directions of rotation when the reverse gear mechanism is in the engaged and the disengaged state.

2. The device according to claim 1, wherein the freewheel clutch, when viewed from the drive means, prevents a rotation of the drive means relative to the first shaft in a clockwise direction and is in a freewheel state when the drive means rotates in a counter-clockwise direction relative to the first shaft.

3. The device according to claim 1, wherein the first shaft is a hollow shaft.

4. The device according to claim 1, wherein the device comprises an overload protection by means of which the reverse gear mechanism can be disengaged, so that the device can be switched over from a braking mode to a drive mode.

5. The device according to claim 1, wherein the device further comprises an additional clutch.

6. The device according to claim 1, wherein the reverse gear mechanism comprises a planetary gear train.

7. The device according to claim 1, wherein the device comprises a braking/freewheel system which can be activated when the reverse gear mechanism is engaged and which causes alternating braking and freewheel modes of the drive means in the braking mode.

8. The device according to claim 1, wherein the reverse gear mechanism comprises a transmission.

9. The device according to claim 1, wherein the freewheel clutch is lockable when the reverse gear mechanism is engaged.

10. The device according to claim 1, wherein the device comprises a measuring device for measuring the braking power in the braking mode and/or the driving power in the drive mode and a microcomputer.

11. The device according to claim 1, wherein the device comprises an activation device for engaging and disengaging the reverse gear mechanism.

12. A vehicle having a pedal drive, comprising:
a vehicle frame having a steering device;
at least one front wheel attached to the steering device via a first wheel axle;
at least one rear wheel, which is attached via a second wheel axle to the vehicle frame, and a device according to claim 1;
a braking device; and
a drive device having a crank which can be driven by pedals, and a chain drive, belt drive or cardan drive which is mounted between the crank and the at least one rear wheel.

13. The vehicle according to claim 12, wherein the reverse gear mechanism is integrated in the at least one rear wheel.

14. The vehicle according to claim 12, wherein the braking device comprises a brake lever, and the reverse gear mechanism can be disengaged when the brake lever is activated.

15. The vehicle according to claim 12, wherein the vehicle comprises a measuring device for measuring the braking power in the braking mode and/or the driving power in the drive mode and a microcomputer.

16. The vehicle according to claim 12, wherein the vehicle comprises an activation device by means of with the switching device can be activated.

17. The vehicle according to claim 12, wherein the vehicle comprises an electric drive by means of which the vehicle can be propelled in the forward direction.

18. The vehicle according to claim 17, wherein the electric drive comprises a programmable microcomputer by means of which the driving power and/or the rotational speed of the electric drive can be set.

19. The vehicle according to claim 17, wherein the vehicle comprises a force sensor by means of which the driving power of the electric drive can be adjusted.

20. The vehicle according to claim 17, wherein the electric motor can also be operated as a generator.

21. The vehicle according to claim 17, wherein an additional motor/generator group is mounted on the at least one rear wheel.

22-23. (canceled)

24. A method for eccentric muscle training, comprising:
providing a vehicle having a pedal drive according to claim 12;
propelling the vehicle in the forward direction;
engaging the reverse gear mechanism by means of the switching device; and
braking the pedals moved into the reverse direction by muscle strength.

25. The method according to claim 24, wherein the propulsion of the vehicle occurs in the forward direction by riding downhill.

26. The method according to claim 24, wherein the propulsion of the vehicle in the forward direction occurs by means of an electric motor.
